(19) United States
(12) Patent Application Publication
(10) Pub. No.: US 2013/0235726 A1
(43) Pub. Date: Sep. 12, 2013

(54) Network Control by Transferring Traffic Between Operation Layers Based on Monitored Traffic Status

(71) Applicants: Frank Frederiksen, Klarus (DK); Troels Emil Kolding, Klarup (DK)

(72) Inventors: Frank Frederiksen, Klarus (DK); Troels Emil Kolding, Klarup (DK)

(73) Assignee: NOKIA SIEMENS NETWORKS OY, ESPOO (FI)

(21) Appl. No.: 13/877,682

(22) PCT Filed: Oct. 4, 2010
(86) PCT No.: PCT/EP10/64713

§ 371 Date: Apr. 30, 2013

(51) Int. Cl. H04W 28/02

(52) U.S. Cl. CPC H04W 28/0247
USPC 370/235

(57) ABSTRACT

The invention relates to apparatuses, a method and computer programs. It defines a network control based on the transfer of traffic between operation layers (e.g. carriers), in response to the traffic status monitored on at least two operation layers, and subsequent network reconfiguration for diminishing energy consumption by switching off radio nodes, when the traffic status indicates that a traffic reduction fulfils a first predetermined condition (e.g. first threshold defining a lower limit for traffic density), and for increasing capacity, when the traffic status indicates that a traffic increase fulfils a second predetermined condition (e.g. second threshold defining an upper limit for traffic density and/or service capability).

### FIELD

The invention relates to apparatuses, a method, system, computer program, computer program product and computer-readable medium.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Modern multimedia devices enable providing users with more services. The usage of multimedia services increases the demand for rapid data transfer which in turn requires investments in radio networks. This has brought cost-effective technologies and network architectures, which also support sustainable development into the beam of light.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: monitor traffic status of at least two operation layers of a communications network; transfer traffic from at least one of the at least two operation layers to at least one other operation layer of the at least two operation layers in such a manner that at least one of the at least two operation layers is emptied still maintaining areal service coverage, reconfigure the at least one other operation layer for service providing purposes, and switch off radio function nodes serving emptied at least one operation layers for diminishing energy consumption, if the traffic status indicates that a traffic reduction fulfills a first predetermined condition, and configure at least one new operation layer and/or reconfigure at least one of the at least two operation layers for increasing capacity, if the traffic status indicates that a traffic increase fulfills a second predetermined condition.

According to another aspect of the present invention, there is provided a method comprising: monitoring traffic status of at least two operation layers of a communications network; if the traffic status indicates that a traffic reduction fulfills a first predetermined condition, transferring traffic from at least one of the at least two operation layers to at least one other operation layer of the at least two operation layers in such a manner that at least one of the at least two operation layers is emptied still maintaining areal service coverage, reconfiguring the at least one other operation layer for service providing purposes, and switching off radio function nodes serving emptied operation layers for diminishing energy consumption; and if the traffic status indicates that a traffic increase fulfills a second predetermined condition, configuring at least one new operation layer and/or reconfiguring at least one of the at least two operation layers for increasing capacity.

According to yet another aspect of the present invention, there is provided an apparatus comprising: means for monitoring traffic status of at least two operation layers of a communications network; means for transferring traffic from at least one of the at least two operation layers to at least one other operation layer of the at least two operation layers in such a manner that at least one of the at least two operation layers is emptied, for reconfiguring the at least one other operation layer for service providing purposes, and for switching off radio function nodes serving emptied at least one operation layers for diminishing energy consumption, if the traffic status indicates that a traffic reduction fulfills a first predetermined condition, and means for configuring at least one new operation layer and/or reconfigure at least one of the at least two operation layers for increasing capacity, if the traffic status indicates that a traffic increase fulfills a second predetermined condition.

According to yet another aspect of the present invention, A computer program embodied on a computer-readable storage medium, the computer program comprising program code for controlling a process to execute a process, the process comprising: monitoring traffic status of at least two operation layers of a communications network; transferring traffic from at least one of the at least two operation layers to at least one other operation layer of the at least two operation layers in such a manner that at least one of the at least two operation layers is emptied, reconfiguring the at least one other operation layer for service providing purposes, and switching off radio function nodes serving emptied at least one operation layers for diminishing energy consumption, if the traffic status indicates that a traffic reduction fulfills a first predetermined condition, and configuring at least one new operation layer and/or reconfigure at least one of the at least two operation layers for increasing capacity, if the traffic status indicates that a traffic increase fulfills a second predetermined condition.

### LIST OF DRAWINGS

Some embodiments of the present invention are described below, by way of example only, with reference to the accompanying drawings, in which

FIGS. 1A and 1B illustrate examples of a system;

FIG. 2 is a flow chart;

FIG. 3 illustrates examples of an apparatus,

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on LTE Advanced, LTE-A, that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. For example, the embodiments are applicable to both frequency division duplex (FDD) and time division duplex (TDD).

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for advanced evolved) needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the (e)NodeB.

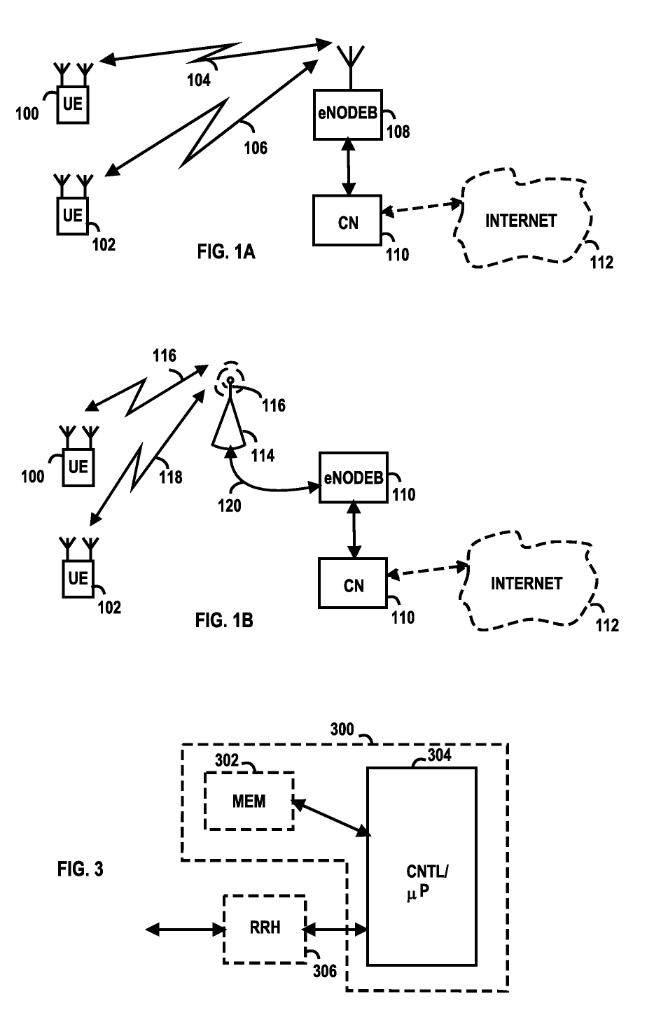

FIGS. 1A and 1B depict examples of simplified system architectures only showing some elements and functional entities, all being logical units, whose implementation may differ from what is shown. The connections shown in FIGS. 1A and 1B are logical connections; the actual physical connections may be different. It is apparent to a person skilled in the art that the system typically comprises also other functions and structures than those shown in FIGS. 1A and 1B.

The embodiments are not, however, restricted to the system given as an example but a person skilled in the art may apply the solution to other communication systems provided with the necessary properties. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), wideband code division multiple access (WCDMA) and systems using ultra-wideband (UWB) technology.

FIG. 1A shows a part of a radio access network of E-UTRA, LTE or LTE-Advanced (LTE-A). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1A shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB includes transceivers, for instance. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving system architecture evolution (SAE) gateway (routing and forwarding user data packets), packet data network gateway (PDN GW), for providing connectivity of user devices (UEs) to external packet data networks, or mobile management entity (MME), etc.

A communications system typically comprises more than one (e)NodeB in which case the (e)NodeBs may also be configured to communicate with one another over links, typically radio links, designed for the purpose. These links may be used for signalling purposes.

The communication system is also able to communicate with other networks, such as a public switched telephone network or the Internet 112.

The user device (also called UE, user equipment, user terminal, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, laptop computer, game console, notebook, and multimedia device. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1A, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1A) may be implemented. It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeB 108 of FIG. 1 may provide any kind of these cells. A cellular radio system may be implemented as a multilayer network including several kinds of cells. Typically, in multilayer networks, one node B provides one kind of a cell or cells, and thus a plurality of node Bs are required to provide such a network structure.

Modern multimedia devices enable providing users with more services. The usage of multimedia services increases the demand for rapid data transfer which in turn requires investments in radio networks. Developed Networks enabling an adequate user experience when modern services and applications are used, typically means higher installation and operating expenses (OPEX). Further, as the power consumption of a base station typically maps directly into the operational expenses (OPEX) of a network operator, technologies enabling reduction of energy consumption of a network have been a focus of interest.

One means to be used in improving the usage of network resources in a cost-effective way is introducing remote radio frequency (RF) heads and base station hotels: the base station is split into two parts: a remote RF head and a baseband radio server typically coupled by a wired link (a wireless link is also possible). This produces a system wherein baseband radio servers may be deployed in an easy-to-access and/or low-cost location while remote RF heads (RRHs) may be mounted on the rooftop close to an antenna. Usually, a remote RF head houses radio-related functions (transmitter RF, receiver RF, filtering etc.) and the base station part carries out other base station functions. Each radio head may produce a separately controlled cell, but they may also constitute a cluster of cells with distributed antennas.

Further, multiple baseband radio servers may be placed in a same location, utilizing same resources, such as power supplies and backhaul connections, while RF heads may be distributed at locations providing desired radio coverage. This concept is supported by open base station architecture initiative (OBSAI) specifications. The concept of multiple remote RF heads coupled to a centralized base station may be referred as a base station (BTS) hotel. Base station hotels with extensive integration and joint processing are also referred to as cloud RAN (C-RAN). One advantage of the BTS hotel architecture lies in its ability to provide cost-effective BTS redundancy.

FIG. 1B shows an example how the BTS hotel concept may be implemented in the system of FIG. 1A. Similar reference numbers refer to similar units, elements, connections etc. Only differences between FIGS. 1A and 1B are explained in this context.

The BTS hotel concept is taken herein only as an example. However, embodiments are not restricted to this concept. For example, the embodiments are applicable to networks, wherein nodes are coupled with optical fibre.

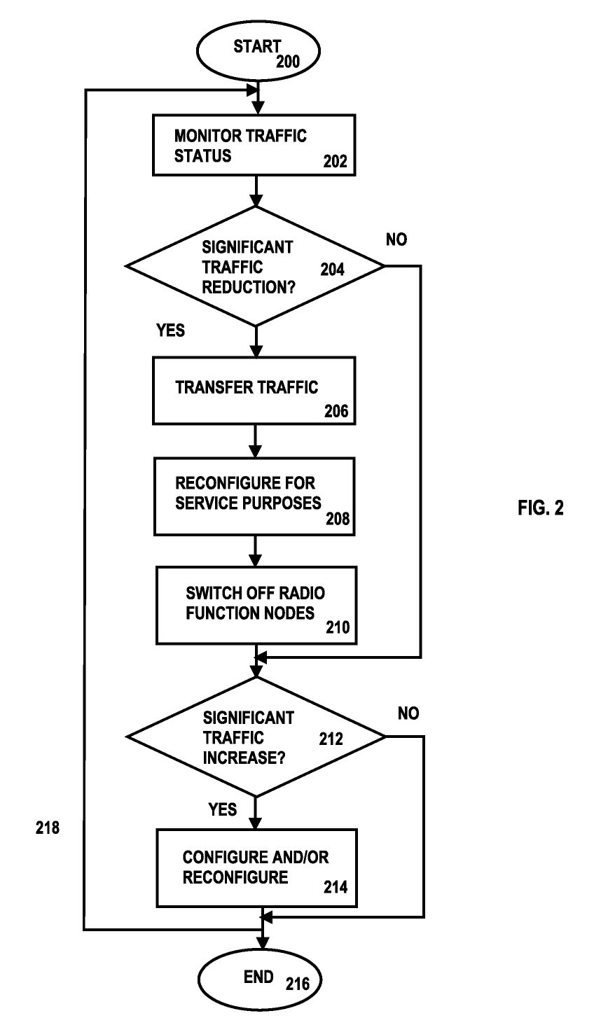

In FIG. 1B, a radio head 114 is placed near antenna 116 and the rest of the base station (in this example eNodeB) 110 is located in a centralized position which may be suitable for multiple base stations. In this example, the link between the radio head 114 and the base station 110 is implemented with an optical fibre connection 120. In the following, some embodiments are disclosed in further details in relation to FIG. 2. The embodiments are especially suitable to be carried out by a centralised network controller which may be located in a node device, host or server or a node device, host or server may be coupled to it.

The embodiment of FIG. 2 is usually related to a base station, node, host, server etc provided with required functionality to carry out base station and/or radio network controller functionalities. In the case a BTS hotel concept is applied, radio functions may be excluded. The embodiment starts in block 200. The embodiment is implemented in a communications network which comprises at least two operation layers.

Operation layers typically mean network operator's transmission/reception layers for network operation.

In one embodiment, one or more of the operation layers may be seen as a “coverage layer” designed to provide coverage, whereas the other layer(s) are able to provide “capacity”.

The operation layers cover at least substantially the same geographical area, and hence an operation layer typically corresponds to a frequency carrier.

It should be noted that the operation layers may apply to layers of a same radio access technology (RAT) as well as to layers of different RATs (for instance WCDMA/HSPA and LTE).

In block 202, traffic status of the at least two operation layers are monitored.

Information on traffic status may be based on the overall load situation in the network. This information may be gathered in many ways, one example is obtaining information from the nodes within the selected area about the number of users or the utilization rate of data transfer resources.

If the traffic status indicates traffic reduction fulfilling a first predetermined condition usually meaning that it affects significantly enough to the utilization of resources consuming energy (block 204), traffic is transferred from at least one of the at least two operation layers to at least one other operation layer of the at least two operation layers in such a manner that at least one of the at least two operation layers is emptied (block 206).

The degree of traffic reduction that is whether the traffic reduction fulfills the first predetermined condition may be evaluated in many ways. One option is to use a threshold which defines a lower limit for traffic density before actions are taken. The threshold may be determined in advance as one operational network parameter. It may also be adjusted according to traffic predictions or statistical information on typical traffic statuses on different times of day or different days of the week. The threshold is typically based on a trade-off between capability to supply adequate capacity and achieving savings in energy consumption and is thus dependent on operator's needs and wishes.

To further clarify the traffic transfer, a simplified example is given. In the example, the at least one layer to be emptied is called a “coverage layer” and the layer receiving traffic is called a “capacity layer”. Typically, the “coverage layer” is the layer that provides best inherent coverage, for example it may be the lowest possible frequency carrier in the operator's network.

The “coverage layer” is emptied by handing off traffic to at least one capacity layer node. This is a traffic steering action which can be accomplished by using various means. The coverage layer is emptied for reconfiguring the layer without loosing active user connections. It should be appreciated that the emptying may be total or partial depending on current radio coverage needs. The area to be emptied may cover the whole of a BTS hotel coverage area, a whole of the coverage area of a radio head, or a part of them, etc.

The traffic may be transferred by letting the user devices to make a “normal” handover to a layer the network prefers or the handover may be initiated by the network and the user devices are thus forced to make a handover.

The handover may be “pushed” by switching off nodes, when user devices usually detect a radio link failure and make a handover. The handover parameters may be set to “force” the user devices to select the preferred capacity layer. It should be appreciated that typically not all the operational layers are emptied to guarantee areal service coverage to users. The achievable energy saving may be maximized by maximizing the number of layers to be emptied the upper limit thus being one not-emptied layer.

In block 208, the at least one other operation layer is reconfigured for service providing purposes. The operation layer which acts as a receiving layer is reconfigured that is it is adjusted to be able to provide services according to current demands. Reconfiguring may include defining areas each radio head serves and/or performing new collaborative operation layers. In a collaborative operation layer, nodes may be changed to diversity nodes for maintaining radio coverage. The nodes may be returned to a “normal” operation mode from a diversity mode as well.

In block 210, radio function nodes serving emptied operation layers are switched off for diminishing energy consumption. This switching may be carried out by switching off radio heads producing radio coverage. In the case node devices are not separated to radio heads and the rest of base station functionalities, switching off radio function nodes may mean switching off radio functionalities of the node device.

In the example, when all traffic has been moved to the “capacity layer” radio function nodes, the “coverage layer” radio function nodes are able to change operation mode: larger cell sizes may be defined for the “coverage layer” in order to switch off some radio function nodes and to let only some “coverage layer” nodes remain active with larger coverage. Due to lower interference, these fewer sites are still able to provide coverage over the full area although the overall capacity of the network is now reduced. It should be understood that this reconfiguration may also be implemented as a step-wise process, where some areas are converted into coverage “islands” before others. In this case, the “coverage layer” radio function nodes that are to be converted into a single coverage “island” are processed as a group.

If the operational layer having the larger cell sizes is able to respond to at least most of traffic needs, the operational layer which originally received the transferred traffic is emptied at least partly by transferring traffic back to the operational layer now having the larger cells sizes and radio function nodes (those ones which are now not needed) of the operational layer which originally received the transferred traffic are switched off. In other words, in the case all traffic can be handled by the “coverage layer” now having larger cells, remaining traffic which currently is on the “capacity layer” may be transferred to the “coverage layer” (or at least part of it) and idle capacity radio function nodes may also be switched off for obtaining further savings in energy consumption. Some of the radio function nodes may be left in a switched-on status depending on the current capacity needs.

If a need for additional network capacity exists, the capacity radio function nodes may still be in operation. For instance, at least some of the capacity radio function nodes may act as diversity nodes.

When traffic increases back to “normal” status, the network may be returned to a normal operation mode that is traffic may be transferred from the extended “coverage layer” back to the “capacity layer”, the “coverage layer” may be reconfigured into smaller capacity cells, and the traffic is balanced. In this context, also capacity nodes which acted as diversity nodes may be returned to a “normal” operational status.

it should be appreciated that even more energy saving from a network perspective may be reached by further expanding the coverage area of the coverage cells by letting the elements (antennas) of more than one cell cooperate and act in a diversity mode. Such a solution may be feasible for networks with very low traffic status.

If the traffic status indicates that a traffic increase fulfills a second predetermined condition (block 212), at least one new operation layer is configured and/or at least one of the at least two operation layers are reconfigured for increasing capacity (block 214).

The fulfilling of the second predetermined condition may be evaluated in many ways. One option is to use a threshold which defines an upper limit for traffic density and/or service capability before actions are taken. The threshold may be determined in advance as one operational network parameter. It may also be adjusted according to traffic predictions or statistical information on typical traffic statuses on different times of day or different days of the week. The threshold is typically dependent on operator's needs and wishes.

If the current network cannot provide sufficient services, one or more new operation layers may be created. If a BTS hotel concept is applied, a new operation layer may be created by switching on more radio heads or directing radio heads serving another area to a hot spot area and making the “old” and “new” radio heads serving this area to perform a collaborative operation layer, for instance. In a collaborative operation layer, nodes may be changed to diversity nodes for maintaining radio coverage. The nodes may be returned to a “normal” operation mode from a diversity mode as well. An operational layer may also be reconfigured by adjusting cell sizes (if more capacity is needed, the cells are typically made smaller), for example.

An option to adapt an existing “maximum” grid of power amplifiers and/or antennas to the user distribution currently present in the network is also provided. Sometimes all of them are needed, but usually time periods exist then only few of them is needed in coverage and/or diversity modes. Since a centralized controller is usually aware of instantaneous traffic in the whole network, it is able to adapt the system to time-varying load.

The adaptation of operation layers is typically initiated as a response to current distribution of users and/or load across the network.

Operation layers may be adapted from one link adaptation interval to another link adaptation interval, for example from one transmission time interval (TTI) to another TTI, provided that for a power amplifier and/or antenna under modification, users do not need the resource. Otherwise before adaptation, users must have been disconnected the resource in question, in which case reconfiguration depends on the release pattern, etc. Typically one TTI corresponds to time duration of 1 ms. Thus, adaptation carried out in one TTI may be called fast or even instantaneous.

Embodiments explained above provide a fast and simple implementation of link adaptation. They utilize network nodes as fast reacting entities that are controlled by a centralised network controller, such as a central processing unit which may synchronize and coordinate operation throughout the network. With this centralised control, it is possible to have dynamic operation of the selected layers, such that an operation layer may comprise one node or a plurality of nodes may cooperate to create a collaborative operation layer and the operation layer configurations may be adapted to current needs.

The centralised network controller may be located in a node, host or server, or it may be placed in the same premises or nearby and be coupled to nodes providing base station and/or network controlling functionalities.

The embodiment ends in block 216. The embodiment is repeatable in many ways. One example is shown by arrow 218 in FIG. 2.

The steps/points, signaling messages and related functions described above in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point. One example of possible changes is that in an embodiment, a possible traffic increase may be monitored before a possible traffic reduction.

It should be understood that transmitting and/or receiving may herein mean preparing a transmission and/or reception, preparing a message to be transmitted and/or received, or physical transmission and/or reception itself, etc on a case by case basis.

Embodiment provides an apparatus which may be any node, host, server or any other suitable apparatus able to carry out processes described above in relation to FIG. 2. FIG. 3 illustrates a simplified block diagram of an apparatus according to an embodiment especially suitable for operating as a node, host or server. The apparatus is suitable for controlling radio heads producing radio cells. The apparatus may include or be located in a centralised network controller which may be situated in the node, host or server or be coupled to it.

An embodiment of a method which may be carried out in a node, host or server is described above in relation to FIG. 2.

As an example of an apparatus according to an embodiment, it is shown an apparatus 300, such as a node device, host or server, including facilities in a control unit 304 (including one or more processors, for example) to carry out functions of embodiments, such as monitoring traffic status and transferring traffic. This is depicted in FIG. 3.

Another example of an apparatus 300 may include at least one processor 304 and at least one memory 302 including a computer program code, the at least one memory and the computer program code configured to, with the at least one processor, cause the apparatus at least to: monitor traffic status of at least two operation layers of a communications network, transfer traffic from at least one of the at least two operation layers to at least one other operation layer of the at least two operation layers in such a manner that at least one of the at least two operation layers is emptied, reconfigure the at least one other operation layer for service providing purposes, and switch off radio function nodes serving emptied at least one operation layers for diminishing energy consumption, if the traffic status indicates that a traffic reduction fulfills a first predetermined condition, and configure at least one new operation layer and/or reconfigure at least one of the at least two operation layers for increasing capacity, if the traffic status indicates that a traffic increase fulfills a second predetermined condition.

Yet another example of an apparatus comprises means 304 for monitoring traffic status of at least two operation layers of a communications network, means 304 for transferring traffic from at least one of the at least two operation layers to at least one other operation layer of the at least two operation layers in such a manner that at least one of the at least two operation layers is emptied, reconfiguring the at least one other operation layer for service providing purposes, and switching off radio function nodes serving emptied at least one operation layers for diminishing energy consumption, if the traffic status indicates that a traffic reduction fulfils a first predetermined condition, and means 304 for configuring at least one new operation layer and/or reconfiguring at least one of the at least two operation layers for increasing capacity, if the traffic status indicates that a traffic increase fulfils a second predetermined condition.

Yet another example of an apparatus comprises a monitoring unit 304 configured to monitor traffic status of at least two operation layers of a communications network, a controller 304 configured to transfer traffic from at least one of the at least two operation layers to at least one other operation layer of the at least two operation layers in such a manner that at least one of the at least two operation layers is emptied, to reconfigure the at least one other operation layer for service providing purposes, and to switch off radio function nodes serving emptied at least one operation layers for diminishing energy consumption, if the traffic status indicates that a traffic reduction fulfills a first predetermined condition, and to configure at least one new operation layer and/or reconfigure at least one of the at least two operation layers for increasing capacity, if the traffic status indicates that a traffic increase fulfills a second predetermined condition. The monitoring unit and the controller are included in the microprocessor 304 in the example of FIG. 3. They may be implemented as separate units, modules or as a chip set, etc as well.

It should be understood that the apparatuses may include or be coupled to other units or modules etc, such as radio heads, used in or for transmission/reception. However, they are irrelevant to the embodiments and therefore they need not to be discussed in more detail herein. The radio heads are depicted in FIG. 3 by using reference number 306. The connection between a radio head and the apparatus is typically implemented as a wired link, such as an optical fibre.

Although the apparatus has been depicted as one entity, different modules and memory may be implemented in one or more physical or logical entities.

The apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above.

Other embodiments provide computer programs embodied on a computer readable medium, configured to control a processor to perform embodiments of the methods described above. The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
monitor traffic status of at least two operation layers of a communications network;
transfer traffic from at least one of the at least two operation layers to at least one other operation layer of the at least two operation layers in such a manner that at least one of the at least two operation layers is emptied, reconfigure the at least one other operation layer for service providing purposes, and switch off radio function nodes serving emptied at least one operation layers for diminishing energy consumption, if the traffic status indicates that a traffic reduction fulfills a first predetermined condition, and
configure at least one new operation layer and/or reconfigure at least one of the at least two operation layers for increasing capacity, if the traffic status indicates that a traffic increase fulfills a second predetermined condition.

2. The apparatus of claim 1, wherein an operation layer corresponds to a frequency carrier.

3. The apparatus of claim 1, wherein the first predetermined condition for traffic reduction is based on a threshold which defines a lower limit for traffic density and the second predetermined condition for traffic increase is based on a threshold which defines an upper limit for traffic density and/or service capability.

4. The apparatus of claim 1, wherein the traffic transfer is carried out by using handovers, the handover parameters of which direct user devices to the operation layer to which the traffic is transferred.

5. The apparatus of claim 1, wherein the switching off radio function nodes is carried out by switching off radio heads producing radio coverage or by switching off radio functionalities of a node device.

6. The apparatus of claim 1, wherein an operation layer comprises one node or a plurality of nodes that cooperates to create a collaborative operation layer.

7. The apparatus of claim 6, wherein in the collaborative operation layer, at least one node is changed to a diversity node for maintaining radio coverage.

8. The apparatus of claim 1, wherein after the at least one operation layer is emptied, larger cell sizes for this operation layer are defined.

9. The apparatus of claim 8, wherein if the operational layer having the larger cell sizes is able to respond to at least most of traffic needs, the operational layer which originally received the transferred traffic is emptied at least partly by transferring traffic back to the operational layer having the larger cells sizes and radio function nodes of the operational layer which originally received the transferred traffic are switched off.

10. The apparatus of claim 1, the apparatus comprising a node, host or server.

11. A computer program comprising program instructions which, when loaded into the apparatus, constitute the modules of claim 1.

12. A method comprising:
monitoring traffic status of at least two operation layers of a communications network;
if the traffic status indicates that a traffic reduction fulfills a first predetermined condition,
transferring traffic from at least one of the at least two operation layers to at least one other operation layer of the at least two operation layers in such a manner that at least one of the at least two operation layers is emptied, reconfiguring the at least one other operation layer for service providing purposes, and
switching off radio function nodes serving emptied operation layers for diminishing energy consumption; and
if the traffic status indicates that a traffic increase fulfills a second predetermined condition,
configuring at least one new operation layer and/or reconfiguring at least one of the at least two operation layers for increasing capacity.

13. The method of claim 12, wherein an operation layer corresponds to a frequency carrier.

14. The method of claim 12, wherein the first predetermined condition for traffic reduction is based on a threshold which defines a lower limit for traffic density and the second predetermined condition for traffic in-crease is based on a threshold which defines an upper limit for traffic density and/or service capability.

15. The method of claim 12, further comprising carrying out the traffic transfer by using handovers, the handover parameters of which direct user devices to the operation layer to which the traffic is transferred.

16. The method of claim 12, further comprising carrying out the switching off radio function nodes by switching off radio heads producing radio coverage or by switching off radio functionalities of a node device.

17. The method of claim 12, wherein an operation layer comprises one node or a plurality of nodes that co-operates to create a collaborative operation layer.

18. The method of claim 17, further comprising changing in the collaborative operation layer at least one node to a diversity node for maintaining radio coverage.

19. The method of claim 12, further comprising defining after the at least one operation layer is emptied, larger cell sizes for this operation layer.

20. The method of claim 12, further comprising:
if the operational layer having the larger cell sizes is able to respond to at least most of traffic needs,
emptying the operational layer which originally received the transferred traffic at least partly by transferring traffic back to the operational layer having the larger cells sizes and radio function nodes of the operational layer which originally received the transferred traffic are switched off.

21. An apparatus comprising:
means for monitoring traffic status of at least two operation layers of a communications network;
means for transferring traffic from at least one of the at least two operation layers to at least one other operation layer of the at least two operation layers in such a manner that at least one of the at least two operation layers is emptied, for reconfiguring the at least one other operation layer for service providing purposes, and for switching off radio function nodes serving emptied at least one operation layers for diminishing energy consumption, if the traffic status indicates that a traffic reduction fulfills a first predetermined condition, and
means for configuring at least one new operation layer and/or reconfiguring at least one of the at least two operation layers for increasing capacity, if the traffic status indicates that a traffic increase fulfills a second predetermined condition.

22. A computer program embodied on a computer-readable storage medium, the computer program comprising program code for controlling a process to execute a process, the process comprising:
monitoring traffic status of at least two operation layers of a communications network;
transferring traffic from at least one of the at least two operation layers to at least one other operation layer of the at least two operation layers in such a manner that at least one of the at least two operation layers is emptied, reconfiguring the at least one other operation layer for service providing purposes, and switching off radio function nodes serving emptied at least one operation layers for diminishing energy consumption, if the traffic status indicates that a traffic reduction fulfills a first predetermined condition, and
configuring at least one new operation layer and/or reconfiguring at least one of the at least two operation layers for increasing capacity, if the traffic status indicates that a traffic increase fulfills a second predetermined condition.

23. The computer program of claim 22, wherein an operation layer corresponds to a frequency carrier.

24. The computer program of claim 22, wherein the first predetermined condition for traffic reduction is based on a threshold which defines a lower limit for traffic density and the second predetermined condition for traffic increase is based on a threshold which defines an upper limit for traffic density and/or service capability.

25. The computer program of claim 22, wherein the traffic transfer is carried out by using handovers, the handover parameters of which direct user devices to the operation layer to which the traffic is transferred.

26. The computer program of claim 22, wherein the switching off radio function nodes is carried out by switching off radio heads producing radio coverage or by switching off radio functionalities of a node device.

27. The computer program of claim 22, wherein an operation layer comprises one node or a plurality of nodes that cooperates to create a collaborative operation layer.

28. The computer program of claim 27, wherein in the collaborative operation layer, at least one node is changed to a diversity node for maintaining radio coverage.

29. The computer program of claim 22, wherein after the at least one operation layer is emptied, larger cell sizes for this operation layer are defined.

30. The computer program of claim 22, wherein if the operational layer having the larger cell sizes is able to respond to at least most of traffic needs, the operational layer which originally received the transferred traffic is emptied at least partly by transferring traffic back to the operational layer having the larger cells sizes and radio function nodes of the operational layer which originally received the transferred traffic are switched off.
